(19) United States
(12) Patent Application Publication
(10) Pub. No.: US 2023/0308836 A1
(43) Pub. Date: Sep. 28, 2023

(54) INFORMATION PROCESSING SYSTEM, AND METHOD OF INFORMATION PROCESSING

(71) Applicant: HONDA MOTOR CO., LTD., Tokyo (JP)

(72) Inventors: Yuiko Kumagai, Tokyo (JP); Takashi Miyata, Tokyo (JP); Taiki Yamada, Tokyo (JP)

(21) Appl. No.: 18/170,689

(22) Filed: Feb. 17, 2023

(30) Foreign Application Priority Data
Mar. 23, 2022 (JP) 2022-047409

(51) Int. Cl. H04W 4/029; H04W 4/02

(52) U.S. Cl. CPC H04W 4/029; H04W 4/023; G06F 18/211

(57) ABSTRACT

An information processing system includes a position acquisition unit that acquires the position of a user, a context information acquisition unit that acquires context information corresponding to the position, and a content presentation control unit that controls presentation of a content based on the context information. The context information includes information on easiness of recognition of a feature at the position, the feature relating to the content, and the content presentation control unit controls the presentation of the content based on the easiness of recognition of the feature at the position.

### INCORPORATION BY REFERENCE

The present application claims priority under 35 U.S.C. § 119 to Japanese Patent Application No. 2022-047409 filed on Mar. 23, 2022. The content of the application is incorporated herein by reference in its entirety.

### BACKGROUND OF THE INVENTION

### Field of the Invention

The present invention relates to an information processing system, and a method of information processing.

### Description of the Related Art

There are systems that introduce contents or propose reproduction of the contents to users. For example, Japanese Patent Laid-Open No. 2005-300772 discloses a technique of extracting and introducing musical pieces that match user preferences. Japanese Patent Laid-Open No. 2018-63133 discloses a technique of selecting a content corresponding to the traveling status of a vehicle (for example, vehicle position information, traffic information, and vehicle speed information) and proposing reproduction of the content to an occupant of the vehicle.

However, the conventional techniques have room for improvement in terms of suppressing decrease in user acceptability for the presented content.

Specifically, when a user receives provision of a content in a content distribution service for providing users with the contents corresponding to the locations where the respective users are present, the user may have difficulty in instantaneously understanding why he or she receives provision of the content. In that case, the acceptability for the content decreases.

An object of the present invention is to provide an information processing system and a method of information processing, capable of suppressing decrease in user acceptability.

### SUMMARY OF THE INVENTION

One aspect of the present invention is an information processing system, including a position acquisition unit configured to acquire a position of a user, a context information acquisition unit configured to acquire context information corresponding to the position, and a content presentation control unit configured to control presentation of a content based on the context information. The context information includes information on easiness of recognition of a feature at the position, the feature being in relation to the content, and the content presentation control unit controls the presentation of the content based on the easiness of recognition of the feature at the position.

In the information processing system in one aspect of the present invention, the content presentation control unit presents the content relating to the feature, when the easiness of recognition of the feature at the position is equal to or more than a prescribed value.

The information processing system in one aspect of the present invention includes a recognition level estimation unit configured to estimate a recognition level of the user with respect to the content. When the easiness of recognition of the feature at the position is equal to or more than the prescribed value, and the recognition level of the user with respect to the content relating to the feature is equal to or more than a prescribed value, the content presentation control unit presents the content relating to the feature.

The information processing system in one aspect of the present invention includes a workload estimation unit configured to estimate a status of load of a work performed by the user. When the easiness of recognition of the feature at the position is less than the prescribed value, the recognition level of the user with respect to the content relating to the feature is equal to or more than the prescribed value, and a magnitude of the load of the work is less than a prescribed value, the content presentation control unit presents the content relating to the feature.

In the information processing system in one aspect of the present invention, the information on the easiness of recognition includes information on visibility of the feature at the position.

In the information processing system in one aspect of the present invention, the context information is set for the feature with the visibility being equal to or more than a prescribed value.

In the information processing system in one aspect of the present invention, the information on the easiness of recognition includes information on easiness of identification of the feature at the position.

In the information processing system in one aspect of the present invention, the easiness of identification is set based on the number of features of an identical kind that are present within a fixed range from the position.

One aspect of the present invention is a method of information processing, including a first step of a computer acquiring a position of a user, a second step of the computer acquiring context information corresponding to the position, and a third step of the computer controlling presentation of a content based on the context information. The context information includes information on easiness of recognition of a feature at the position, the feature being in relation to the content, and in the third step, the presentation of the content is controlled based on the easiness of recognition of the feature at the position.

### Advantageous Effects of Invention

According to one aspect of the invention, the decrease in user acceptability can be suppressed.

### BRIEF DESCRIPTION OF THE DRAWINGS

FIG. 1 shows the configuration of an information processing system according to an embodiment of the present invention;

FIG. 2 shows a functional configuration of client equipment;

FIG. 3 shows a functional configuration of a database server;

FIG. 4 shows a functional configuration of a content distribution server;

FIG. 5 shows a functional configuration of an information processing server;

FIG. 6 is a flowchart showing operation of the information processing system; and

FIG. 7 is a flowchart of content distribution control processing.

### DETAILED DESCRIPTION OF THE PREFERRED EMBODIMENT

Hereinafter, an embodiment of the present invention will be described with reference to the drawings.

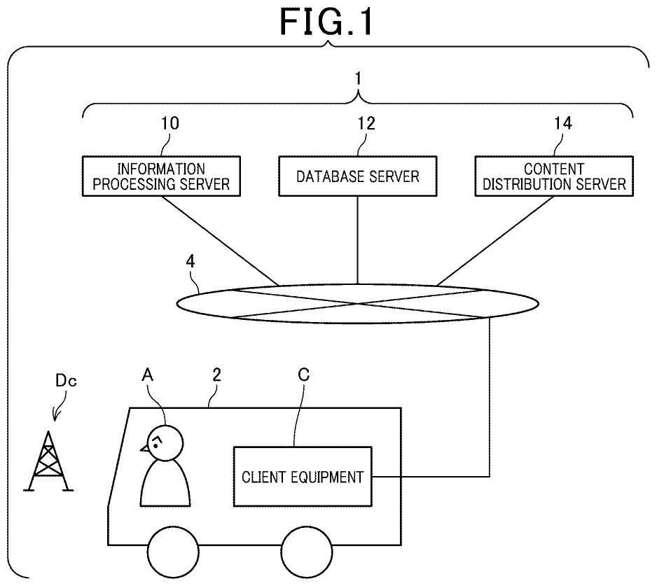

FIG. 1 shows the configuration of an information processing system 1 according to a present embodiment.

The information processing system 1 is a system that provides content distribution service to client equipment C through an electric communication line 4 such as the Internet. The content distribution service in the present embodiment is a service that distributes a content Da corresponding to a current position (hereinafter referred to as “current position Db”) of the client equipment C in a timely manner. The content Da distributed in the content distribution service is determined based on a feature (hereinafter referred to as “visible feature Dc”) that can visually be recognized by a user A of the client equipment C at the current position Db.

In the present embodiment, the content Da is data including appropriate information such as music, videos, and various texts. The visible feature Dc is a natural or man-made object present on the ground, and corresponds to landmarks and landscapes (such as mountains, seas, rivers, grasslands, and illuminations).

The information processing system 1 of the present embodiment further controls the distribution of the content Da based on the easiness of recognition of the visible feature Dc at the current position Db, and thereby distributes appropriate content Da in accordance with a recognition status of the visible feature Dc recognized by the user A. This makes it possible to reduce distribution of the content Da relating to the visible feature Dc that is highly likely not to be visually recognized by the user A, i.e., distribution of the content Da based on the reason unclear for the user A, so that the decrease in acceptability of the user A for the content Da can be suppressed.

The configuration regarding the information processing system 1 is now described in detail.

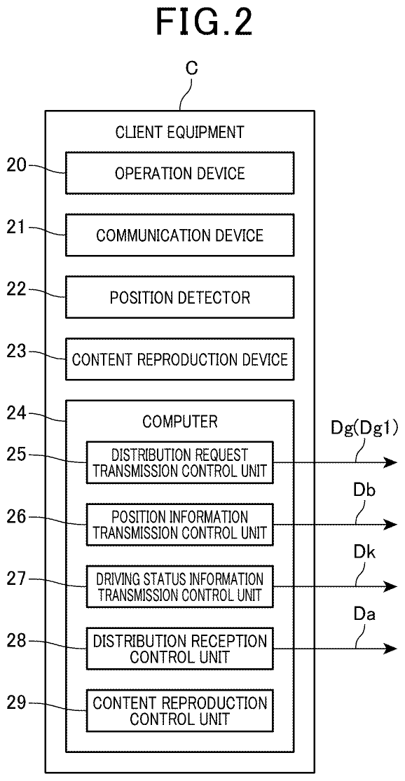

FIG. 2 shows a functional configuration of the client equipment C.

The client equipment C is the equipment that moves with the user A, and receives distribution of the content Da from the information processing system 1 (a content distribution server 14). Such client equipment C is, for example, a portable device such as a smartphone, a wearable device such as a wearable computer, and an in-vehicle device mounted on a vehicle 2 (FIG. 1) that accommodates the user A.

The client equipment C in the present embodiment is an in-vehicle device including an operation device 20, a communication device 21, a position detector 22, a content reproduction device 23, and a computer 24 as shown in FIG. 2.

The operation device 20 is a device that accepts operation of the user A, such as buttons and a touch panel.

The communication device 21 is a device (transmitter/receiver, circuit) that communicates with the content distribution server 14 through the electric communication line 4.

The position detector 22 is a device that detects the current position Db. The position detector 22 in the present embodiment includes a global navigation satellite system (GNSS) receiver that receives positioning signals transmitted from a plurality of positioning satellites and identifies the current position Db based on these positioning signals.

The content reproduction device 23 is a device that reproduces various contents Da such as music, videos, and text information.

The computer 24 has a computer including a processor such as a central processing unit (CPU) or a micro processing unit (MPU), a memory device (also referred to as a main storage device) such as a read only memory (ROM) and a random access memory (RAM), a storage device (also referred to as a sub storage device) such as a hard disk drive (HDD) and a solid state drive (SSD), and an interface circuit for connecting various peripheral devices (such as the operation device 20, the communication device 21, the position detector 22, and the content reproduction device 23).

As the processor executes computer programs stored in the memory device or the storage device, various functions regarding the client computer that receives the content distribution service of the information processing system 1 are implemented.

Specifically, the computer 24 includes, as a functional configuration, a distribution request transmission control unit 25, a position information transmission control unit 26, a driving status information transmission control unit 27, a distribution reception control unit 28, and a content reproduction control unit 29.

When it is determined that there is an operation (instruction) of the user A or that the user A is present at a prescribed place, the distribution request transmission control unit 25 executes control to transmit a content distribution request Dg to the content distribution server 14 from the communication device 21. The determination of whether or not the user A is in the prescribed place can be executed using publicly-known or well-known technology with use of the position detector 22 and map information. Note that the distribution request transmission control unit 25 may execute such determination, or the computer 24 may include a function unit used for such determination, separately from the distribution request transmission control unit 25. The distribution request transmission control unit 25 also transmits user identification information Dg1 (for example, member ID of the content distribution service) that identifies the user A, in the state of being included in or in association with the content distribution request Dg to the content distribution server 14.

The position information transmission control unit 26 executes control to transmit the current position Db to the content distribution server 14 from the communication device 21, and the driving status information transmission control unit 27 executes control to transmit driving status information Dk to the content distribution server 14 from the communication device 21.

The current position Db and the driving status information Dk may be transmitted together with the content distribution request Dg.

The driving status information Dk is the information indicating the status of the driving of the vehicle 2 by a driver (i.e. the work performed by the user A), and more precisely, the information that can be used to estimate the magnitude of the driving load on the driver. Examples of such driving status information Dk may include an operation status such as braking, accelerating, and steering, as well as travel speed, travel road type (public roads, highways, parking lots, etc.), the presence or absence of surrounding obstacles, and inter-vehicle distance. The driving status information transmission control unit 27 acquires these pieces of information from, for example, an in-vehicle electronic control unit (ECU) mounted on the vehicle 2.

The distribution reception control unit 28 executes control to receive the content Da from the content distribution server 14 with the communication device 21, and the content reproduction control unit 29 controls the content reproduction device 23 to reproduce the content Da.

The information processing system 1 is now described in detail.

As shown in FIG. 1, the information processing system 1 includes an information processing server 10, a database server 12, and the content distribution server 14, which are connected to the electric communication line 4 so that they can communicate with each other.

The information processing server 10, the database server 12, and the content distribution server 14 each have a computer including a processor, a memory device, a storage device, a communication device (a receiver and a transmitter) that communicates through the electric communication line 4, and an interface circuit for connecting various peripheral devices.

As the processor executes computer programs stored in the memory device or the storage device, various functions are implemented.

Note that two or more of the information processing server 10, the database server 12, and the content distribution server 14 may be integrated into one server computer. In other words, for example, the information processing server 10 may have the functions of the database server 12 and the content distribution server 14.

The information processing server 10 is a server computer that executes information processing such as acquisition of the current position Db of the client equipment C, and distribution control of the content Da based on the current position Db. A specific functional configuration of the information processing server 10 will be described later.

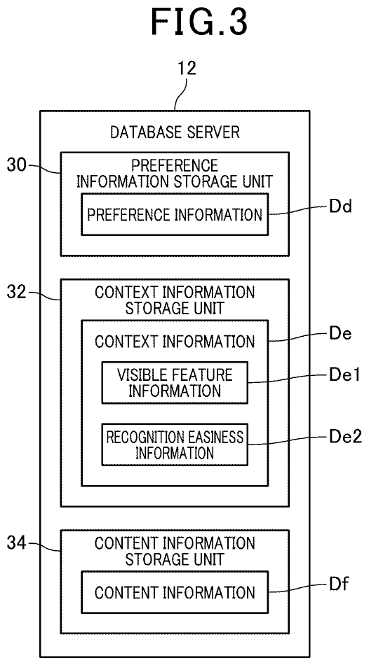

FIG. 3 shows a functional configuration of the database server 12.

The database server 12 is a server computer having a function to store various information required to control the information processing server 10.

Specifically, the database server 12 includes, as a functional configuration, a preference information storage unit 30, a context information storage unit 32, and a content information storage unit 34.

The preference information storage unit 30 has a database that stores preference information Dd in advance. The context information storage unit 32 has a database that stores context information De in advance. The content information storage unit 34 has a database that stores the content information Df regarding the content Da in advance.

The preference information Dd is a variety of information on the preference of the user A regarding the content Da, and more precisely, a variety of information that makes it possible to estimate the content Da that the user A prefers. Examples of such preference information Dd may include information that makes it possible to estimate the tendency of the preference of the user A, such as a viewing history of the content Da or a request history by the user A, or information about personal preferences (favorite genre or artist, date of release, etc.) registered in advance by the user A.

The context information De is the information that includes at least visible feature information De1 on visible features Dc at the current position Db of the user A, and recognition easiness information De2 on the easiness of recognition of the respective visible features Dc. The context information De is set in advance for each predetermined section or place on the map.

The visible feature information De1 is the information on each of the main visible features Dc that are visible from the current position Db. For example, when a lighthouse (landmark) or sea (scenery) can visually be recognized from the current position Db, information such as “sea” and “lighthouse” is recorded on the visible feature information De1.

The recognition easiness information De2 is the information that includes the easiness of identification (distinguishability) of a target visible feature Dc and the visibility (easiness of finding) of the target visible feature Dc.

The score of the easiness of identification is set lower, as the number of the visible features Dc that are present within a fixed range from the current position Db is larger and the number of the visible features Dc of an identical kind (for example, convenience stores belonging to different groups from that of a target visible feature Dc, etc.) that are present within the fixed range is larger.

The visibility score is lower as, for example, the visible features Dc visible from the current position Db are smaller, and the number of shields is larger.

In the present embodiment, such context information De is set for the visible features Dc with the visibility equal to or more than a prescribed value, so that the visible features Dc that are difficult for the user A to find (that have poor visibility) are excluded in advance.

The content information Df is the information about the content Da, the information making it possible to search for the content Da corresponding to the visible feature Dc. In other words, the content information Df includes at least information on the features relating to the content Da. Such features include objects that clearly relate to the content Da (for example, when the content Da is a company song, a building of the company corresponding to the company song, etc.), as well as associative objects which are associated by many listeners and viewers of the content Da with the content Da. When the content Da with a theme of “summer” is taken as an example, features such as “sea” and “pool” are equivalent to the associative objects.

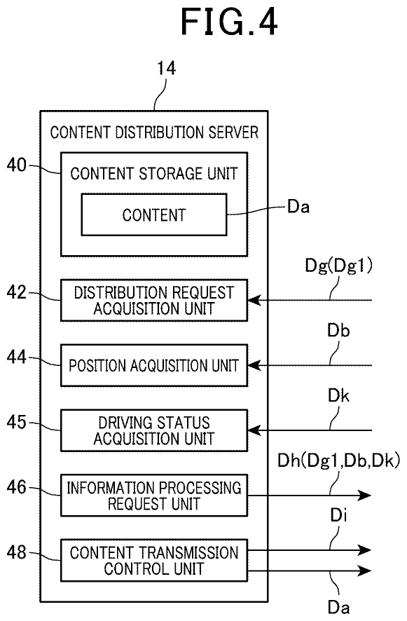

FIG. 4 shows a functional configuration of the content distribution server 14.

The content distribution server 14 is a server computer that distributes to the client equipment C the content Da based on the content distribution control by the information processing server 10.

Specifically, the content distribution server 14 includes, as a functional configuration, a content storage unit 40, a distribution request acquisition unit 42, a position acquisition unit 44, a driving status acquisition unit 45, an information processing request unit 46, and a content transmission control unit 48.

The content storage unit 40 stores the data on the content Da.

The distribution request acquisition unit 42 acquires a content distribution request Dg received by a communication device included in the content distribution server 14. As described above, the content distribution request Dg in the present embodiment includes the user identification information Dg1.

The position acquisition unit 44 acquires the current position Db of the client equipment C, and the driving status acquisition unit 45 acquires the driving status information Dk from the client equipment C.

Note that transmission and reception of the current position Db and the driving status information Dk are performed between the content distribution server 14 and the client equipment C in an appropriate manner. The content distribution server 14 may request the client equipment C to transmit the current position Db and the driving status information Dk, or the client equipment C may voluntarily transmit the current position Db and the driving status information Dk to the content distribution server 14 when the client equipment C transmits the content distribution request Dg.

The information processing request unit 46 executes control to transmit an information processing request Dh to the information processing server 10. The information processing request Dh is a message that requests information processing for determining the content Da to be distributed based on the current position Db of the client equipment C.

Upon acquisition of the content distribution request Dg, the information processing request unit 46 executes control to transmit the information processing request Dh from the communication device to the information processing server 10. In this case, the information processing request unit 46 transmits the user identification information Dg1 on the user A of the client equipment C, the current position Db of the client equipment C, and the driving status information Dk in association with the information processing request Dh.

The content transmission control unit 48 executes control to transmit the content Da from the communication device to the client equipment C based on a distribution instruction Di transmitted by the information processing server 10. The distribution instruction Di includes information on the content Da determined in the information processing, and the content transmission control unit 48 executes control to read the content Da corresponding to the information from the content storage unit 40 and to transmit the content Da.

As a result, the content Da corresponding to the current position Db is distributed to the client equipment C.

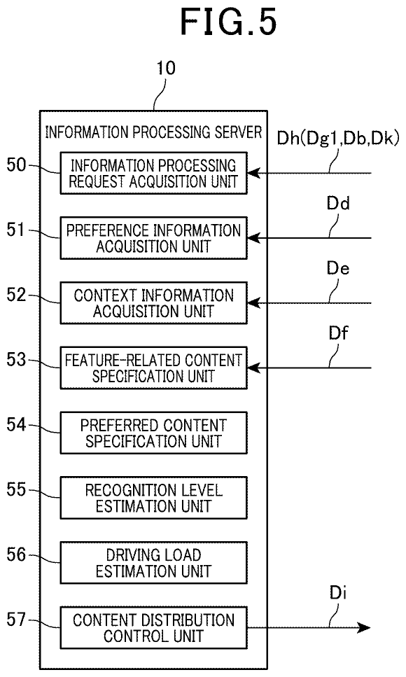

FIG. 5 shows a functional configuration of the information processing server 10.

The information processing server 10 includes, as a functional configuration, an information processing request acquisition unit 50, a preference information acquisition unit 51, a context information acquisition unit 52, a feature-related content specification unit 53, a preferred content specification unit 54, a recognition level estimation unit 55, a driving load estimation unit 56, and a content distribution control unit 57.

The information processing request acquisition unit 50 acquires the information processing request Dh received by the communication device included in the information processing server 10.

The preference information acquisition unit 51 acquires the preference information Dd of the user A from the database server 12 based on the user identification information Dg1 corresponding to the information processing request Dh.

The context information acquisition unit 52 acquires the context information De related to the current position Db from the database server 12, based on the current position Db corresponding to the information processing request Dh.

The feature-related content specification unit 53 specifies the content Da relating to the visible feature Dc.

Specifically, the feature-related content specification unit 53 searches the content information storage unit 34 in the database server 12 with the visible feature DC as a search key, and specifies the content Da corresponding to the visible feature Dc based on the relevant content information Df.

For example, when the visible feature Dc is “sea”, the content information Df in which “sea” is included in the visible feature information Del is extracted as a search result, and the content Da corresponding to the content information Df is specified.

The preferred content specification unit 54 specifies the content Da that matches the preference of the user A based on the preference information Dd.

More specifically, the preferred content specification unit 54 specifies a classification (genre, release date, etc.) and characteristics (content atmosphere, etc.) of the content Da preferred by the user A, based on the preference information Dd. The preferred content specification unit 54 then searches the content information storage unit 34 in the database server 12 with these classification or characteristics as a search key, and specifies the content Da corresponding to the preference of the user A based on the relevant content information Df.

The recognition level estimation unit 55 estimates a recognition level of the user A with respect to the content Da. The recognition level is an index value indicating the degree of possibility that the user A knows the content Da. The recognition level estimation unit 55 in the present embodiment estimates the recognition level, based on the presence or absence of a history that the user A has reproduced the content Da, the number of times that the content Da has been reproduced, a known level or a publicly-known level of the content Da, and the degree of deviation of the content Da from the preference of the user A.

Specifically, the recognition level of the content Da is estimated to be higher, as the number of times of reproduction by the user A is larger, the content Da is more popular, and the content Da is closer to the preference of the user A.

Without being limited to the above-stated method, any publicly-known or well-known technique may be used as the method for estimating the recognition level.

The driving load estimation unit 56 estimates the magnitude of the driving load (hereinafter referred to as “driving load level”) based on the driving status information Dk.

The content distribution control unit 57 determines the content Da to be distributed, based on the context information De, the preference information Dd, and the driving status information Dk, and transmits to the content distribution server 14 the distribution instruction Di that instructs the content distribution server 14 to distribute the content Da.

As a result, the content Da instructed by the distribution instruction Di is distributed from the content distribution server 14 to the client equipment C.

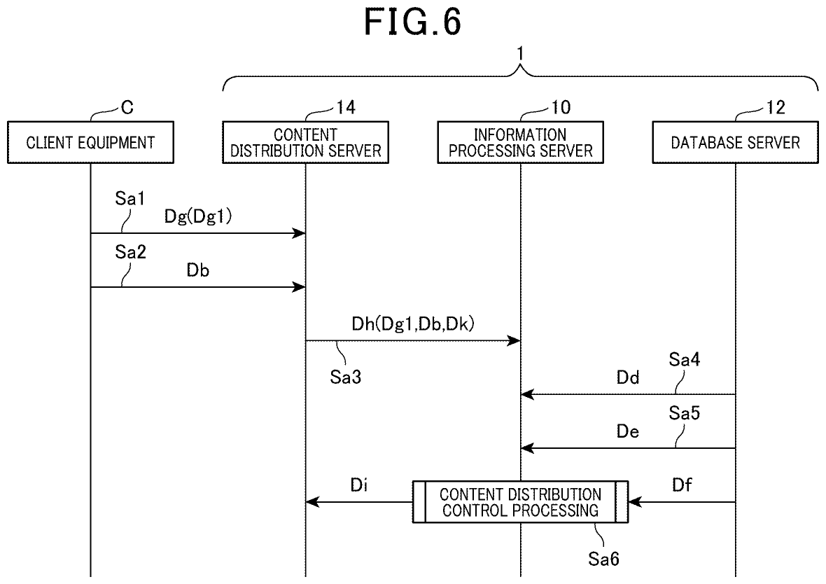

FIG. 6 is a flowchart showing the operation of the information processing system 1.

Upon arrival of appropriate timing, such as the time when the user A issues an instruction, and the time when the vehicle 2 enters a prescribed place, the client equipment C transmits a content distribution request Dg and a current position Db to the content distribution server 14 (steps Sa1, Sa2). Upon reception of the content distribution request Dg, the content distribution server 14 transmits an information processing request Dh to the information processing server 10 (step Sa3). As described before, the information processing request Dh is associated with the user identification information Dg1 on the user A of the client equipment C, the current position Db of the client equipment C, and the driving status information Dk.

Upon reception of the information processing request Dh, the information processing server 10 acquires preference information Dd corresponding to the user identification information Dg1 and context information De corresponding to the current position Db from the database server 12 (steps Sa4 and Sa5).

In the information processing server 10, the content distribution control unit 57 executes content distribution control processing that controls distribution of the content Da based on the context information De, the preference information Dd, and the driving status information Dk (step Sa6).

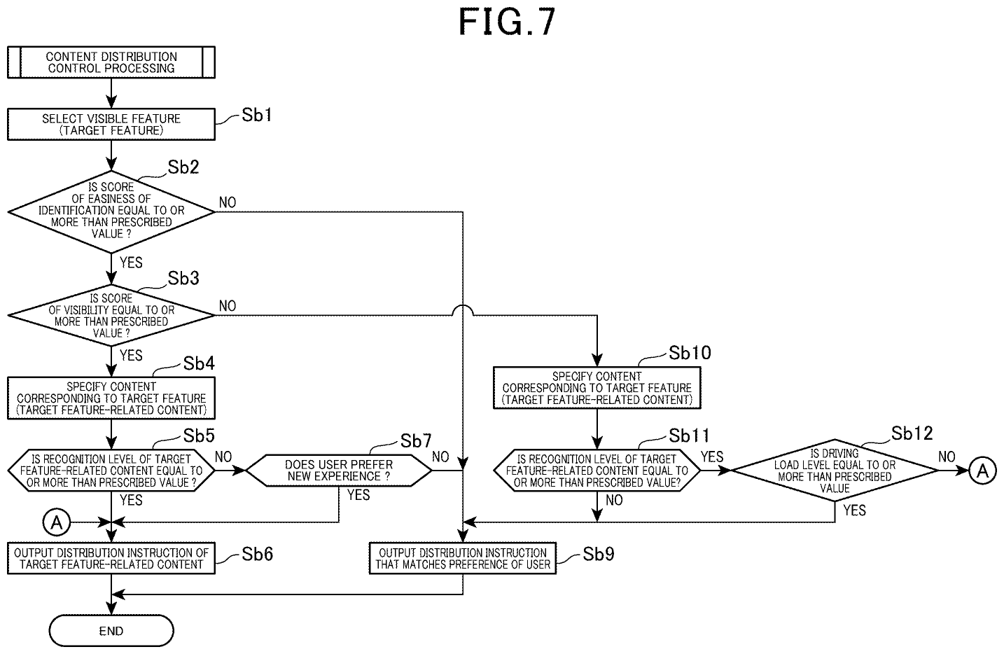

FIG. 7 is a flowchart of the content distribution control processing.

First, the content distribution control unit 57 selects one of the visible features Dc (landmarks, scenery, etc.) that are visible at the current position Db of the user A, based on the visible feature information De1 in the context information De (step Sb1). The selecting method is as appropriate. For example, when there is a plurality of visible features Dc, the selecting method may be for selecting the visible feature Dc which is most certainly visually recognized by the user A at the current position Db, with scale, publicity, or saliency being used as an index.

The content distribution control unit 57 may acquire an advance direction of the vehicle 2 (that is, a view direction of the user A) from the vehicle 2 through the client equipment C, and select one of the visible features Dc positioned in the advance direction based on the current position Db, or may further select the visible feature Dc based on the view range of a general person.

In the following, the visible feature Dc selected in step Sb1 is referred to as “target feature Dct” in order to distinguish it from other features Dc.

The content distribution control unit 57 then determines which content Da to distribute, between the content Da relating to the target feature Dct and the content Da preferred by the user A, based on the recognition easiness information De2 in the context information De.

In more detail, the content distribution control unit 57 selects, in principle, the content Da relating to the target feature Dct as a distribution target when the easiness of recognition of the target feature Dct is equal to or more than a prescribed value, and selects the content Da preferred by the user A as a distribution target when the easiness of recognition is less than the prescribed value. The prescribed value regarding the easiness of recognition is an index value that indicates that many people present at the current position Db are in the state of being able to recognize the target feature Dct.

In the present embodiment, as described above, two evaluation values, including the easiness of identification and the visibility, are set for the easiness of recognition. Which content Da to distribute, between the content Da relating to the target feature Dct and the content Da preferred by the user A, is determined more appropriately in accordance with the respective evaluation values.

Specifically, the content distribution control unit 57 determines whether or not the score of the easiness of identification of the target feature Dct is equal to or more than a prescribed value (step Sb2), and also determines whether or not the score of the visibility of the target feature Dct is equal to or more than a prescribed value (step Sb3).

When the score of the easiness of identification is equal to or more than the prescribed value (Yes in step Sb2), it indicates that the user A is in the situation where the user A can identify (find) the target feature Dct with high certainty.

When the score of the visibility is equal to or more than the prescribed value (Yes in step Sb3), it indicates that the user A is in the situation where the user A can visually recognize (distinguish) the target feature Dct with high certainty.

In other words, when both steps Sb2 and Sb3 are “Yes”, it can be said that the user A recognizes the target feature Dct at the current position Db with high certainty, and even when the user A does not recognize the target feature Dct at the time, the user A is in the situation where the user A can recognize the target feature Dct easily.

Next, in the information processing server 10, the feature-related content specification unit 53 specifies the content Da relating to the target feature Dct based on the target feature Dct (step Sb4). In the following, the content Da specified based on the target feature Dct is referred to as “target feature-related content Dal” in order to distinguish it from other contents Da.

The content distribution control unit 57 then determines whether or not the recognition level of the user A with respect to the target feature-related content Da1 is equal to or more than a prescribed value (step Sb5). Such a recognition level is an estimation value by the recognition level estimation unit 55.

When the recognition level of the user A with respect to the target feature-related content Da1 is equal to or more than the prescribed value (Yes in step Sb5), it indicates that the user A already knows the detail of the target feature-related content Dal with high certainty, and the user A is in the situation where the user A easily grasps the relation between the target feature-related content Dal and the target feature Dct.

Accordingly, the content distribution control unit 57 determines the target feature-related content Da1 as the content Da to be distributed, and outputs a distribution instruction Di that instructs distribution of the target feature-related content Dal (step Sb6).

As a result, the target feature-related content Da1, distributed in the situation where the user A recognizes the target feature Dct or it is easy for the user A to recognize the target feature Dct (Yes in both steps Sb2 and Sb3), is the target feature-related content Da1 having relation to the target feature Dct, the relation being understood by the user A with high certainty. This makes it possible to suppress the decrease in acceptability of the user A for the content Da.

However, even in the situation where the user A recognizes the target feature Dct or it is easy for the user A to recognize the target feature Dct (Yes in both steps Sb2 and Sb3), it is unlikely that the user A understands the relation between the target feature-related content Da1 and the target feature Dct when the recognition level of the user A with respect to the target feature-related content Da1 is less than the prescribed value (No in step Sb5). In this case, the content distribution control unit 57 determines whether or not to select the target feature-related content Da1 as the content Da to be distributed, based on whether or not the target feature-related content Dal is suitable for the user A.

Specifically, when it is indicated or estimated that the user A tends to prefer new experience based on the preference information Dd on the user A (Yes in step Sb7), the content distribution control unit 57 determines the target feature-related content Da1 as the content Da to be distributed (step Sb6). As a result, even when the target feature-related content Da1 with which the user A is not familiar is distributed, the decrease in acceptability of the user A can be suppressed.

Since the target feature-related content Da1 is distributed in the situation where the target feature Dct is easily recognized, the user A easily notices the relation of the target feature-related content Da1 with the target feature Dct, even when the user A is not familiar with the target feature-related content Da1. As a result, the user A can even more enjoy the target feature-related content Da1.

Meanwhile, when the user A does not tend to prefer new experience (No in step Sb7), the preferred content specification unit 54 specifies the content Da that matches the preference of the user A based on the preference information Dd so as to prevent distribution of the content Da not desired by the user A. The content distribution control unit 57 outputs a distribution instruction Di that instructs the distribution of such a content Da (step Sb9).

When the easiness of recognition of the target feature Dct is low (“No” in one of steps Sb2 and Sb3), the content distribution control unit 57 determines the content Da to be distributed as follows.

Specifically, when the score of the easiness of identification, out of the easiness of recognition of the target feature Dct, is low (No in step Sb2), even when the target feature-related content Da1 is distributed, it is highly likely that the user A is unable to recognize the target feature Dct in relation with the target feature-related content Da1. Therefore, in this case, the content distribution control unit 57 advances the processing procedure to step Sb9 to output a distribution instruction Di that instructs distribution of the content Da that matches the preference of the user A, instead of the target feature-related content Da1.

Meanwhile, when the score of the visibility, out of the easiness of recognition of the target feature Dct, is low (No in step Sb3), it indicates the situation where the target feature Dct is simply hard to find.

Accordingly, the distribution of the target feature-related content Da1 may possibly function as a trigger to cause the user A to find the target feature Dct that is in relation to the target feature-related content Da1.

In this connection, the content distribution control unit 57 first specifies the target feature-related content Da1 based on the target feature Dct (step Sb10), and determines whether or not the recognition level of the user A with respect to the target feature-related content Da1 is equal to or more than a prescribed value (step Sb11). When the recognition level is less than the prescribed value (No in step sb11), it is unlikely that the user A associates the target feature-related content Da1 with the target feature Dct. Accordingly, the content distribution control unit 57 advances the processing procedure to step Sb9 to output the distribution instruction Di that instructs distribution of the content Da that matches the preference of the user A.

On the contrary, when the recognition level is equal to or more than the prescribed value (Yes in step Sb11), it is highly likely that the user A associates the target feature-related content Dal with the target feature Dct and finds the target feature Dct. In this case, the content distribution control unit 57 determines whether or not the driving load level estimated by the driving load estimation unit 56 is equal to or more than a prescribed value (step Sb12). When the driving load level is less than the prescribed value (No in step Sb12), it is relatively highly likely that the user A has time to find the surrounding target feature Dct.

Accordingly, the content distribution control unit 57 advances the processing procedure to step Sb6 to determine the target feature-related content Da1 as the content Da to be distributed.

As a result, the user A can notice the surrounding target feature Dct by receiving the distribution of the target feature-related content Da1, so that the user A can enjoy new discovery.

Meanwhile, when the driving load level is equal to or more than the prescribed value (YES in step Sb12), the user A is focusing on driving operation, and it is highly likely that the user A has no time to find the surrounding target feature Dct. Accordingly, the content distribution control unit 57 advances the processing procedure to step Sb9 to output the distribution instruction Di that instructs distribution of the content Da that matches the preference of the user A.

As a result, in the situation where it is highly likely that the target feature Dct is not recognizable even when the user A is familiar with the target feature-related content Da1, the content Da that matches the preference is distributed in place of the target feature-related content Da1. This makes it possible to suppress the decrease in acceptability of the user A for the distributed content Da.

In the content distribution control processing, when no target feature Dct is present as a result of the processing in step Sb1 (when the visible feature Dc is zero), the content distribution control unit 57 advances the processing procedure to step Sb9 to select the content Da that matches the preference of the user A as a distribution target.

The present embodiment demonstrates following effects.

The information processing system 1 of the present embodiment includes the position acquisition unit 44 that acquires the current position Db of the user A, the context information acquisition unit 52 that acquires the context information De corresponding to the current position Db, and the content distribution control unit 57 that controls distribution of the content Da based on the context information De. The context information De includes the recognition easiness information De2 on the easiness of recognition of the visible feature Dc relating to the content Da at the current position Db, and the content distribution control unit 57 controls distribution of the content Da based on the recognition easiness information De2.

With the configuration, the content Da is distributed in accordance with the status of recognition of the visible feature Dc by the user A. Therefore, it is possible to reduce the cases where the acceptability of the user A for the content Da decreases because it is difficult for the user A to understand the relation between the distributed content Da and the visible feature Dc.

In the information processing system 1 of the present embodiment, when the easiness of recognition of the visible feature Dc at the current position Db is equal to or more than a prescribed value (when both steps Sb2 and Sb3 in FIG. 7 are Yes), the content distribution control unit 57 distributes the content Da (target feature-related content Da1) relating to the visible feature Dc.

With the configuration, since the content Da relating to the visible feature Dc is distributed in the situation where the user A easily recognizes the visible feature Dc, it is possible to prevent the situation where the user A is unable to understand the relation between the distributed content Da and the visible feature Dc.

The information processing system 1 of the present embodiment includes the recognition level estimation unit 55 that estimates the recognition level of the user A with respect to the content Da. When the easiness of recognition of the visible feature Dc at the current position Db is equal to or more than the prescribed value, and the recognition level of the user A with respect to the content Da relating to the visible feature Dc is equal to or more than the prescribed value (Yes in step Sb5 in FIG. 7), the content distribution control unit 57 distributes the content Da (target feature-related content Da1) relating to the visible feature Dc.

With the configuration, the target feature-related content Da1 is distributed when the user A is in the situation where the user A easily recognizes the visible feature Dc and the user A is familiar with the target feature-related content Da1. Therefore, it is possible to reliably prevent the situation where the user A is unable to understand the relation between the distributed content Da and the visible feature Dc.

The information processing system 1 of the present embodiment includes the driving load estimation unit 56 that estimates the status of the load of driving performed by the user A. When the easiness of recognition of the visible feature Dc at the current position Db is less than the prescribed value (when No in step Sb3 in FIG. 7), the recognition level of the user A with respect to the content Da relating to the visible feature Dc is equal to or more than the prescribed value, and the driving load level is less than the prescribed value (when step Sb11 is Yes and step Sb12 is No in FIG. 7), the content distribution control unit 57 distributes the content Da (target feature-related content Da1) relating to the visible feature Dc.

With the configuration, even in the situation where it is not easy for the user A to recognize (to visually recognize in the present embodiment) the visible feature Dc, distribution of the target feature-related content Da1 functions as a trigger to cause the user A to notice the surrounding target feature Dc, so that the user A can enjoy new discovery.

In the information processing system 1 of the present embodiment, the recognition easiness information De2 includes information on visibility of the visible feature at the current position Db.

With the configuration, the distribution of the content Da can be controlled based on recognition difficulty attributed to the visibility.

In the information processing system 1 of the present embodiment, the context information De is set for the visible feature Dc with the visibility being equal to or more than a prescribed value.

With the configuration, the visible features Dc that are hardly recognized by the user A can be excluded in advance.

In the information processing system 1 of the present embodiment, the information on the easiness of recognition includes information on easiness of identification of the visible feature Dc at the current position Db.

With the configuration, the distribution of the content Da can be controlled based on recognition difficulty attributed to the easiness of identification.

In the information processing system 1 of the present embodiment, the easiness of identification is set based on the number of visible features Dc of an identical kind that are present within a fixed range from the current position Db.

With the configuration, distribution of the content Da can be controlled in accordance with the situation where the target visible feature Dc is hardly recognized due to a large number of visible features Dc of the identical kind.

The embodiment described merely an example of one aspect of the present invention. Specifically, the embodiment described can optionally be deformed and applied without departing from the concept of the present invention, and these embodiment, deformations, and aspects relevant to the application can optionally be combined.

In the embodiment described, the aspect of distributing the content Da has been illustrated as an example of presenting the content to the user A.

However, without being limited to this example, the aspect of introducing or proposing the content Da is also possible.

In the embodiment described, although the case where the user A moves by riding in the vehicle 2 has been illustrated, the user A may move by riding in other vehicles (such as airplanes or ships) or move on foot.

In the embodiment described, although the driving operation is illustrated as a work performed by the user A, the work is not limited to the driving operation, and may be any work.

The configuration diagrams shown in FIGS. 1 to 5 are diagrams showing the component members classified according to main processing contents for easy understanding of the present invention. Therefore, each component member may be classified into further more component members according to the processing contents. The component members may also be classified so that one component member executes further more processings.

In the flowcharts shown in FIGS. 6 and 7, the order of each step may optionally be changed without departing from the concept of the present invention.

(Configuration Supported by Disclosure of Specification)

The disclosure of the specification supports the following configurations.

(Configuration 1)

An information processing system, including: a position acquisition unit configured to acquire a position of a user; a context information acquisition unit configured to acquire context information corresponding to the position; and a content presentation control unit configured to control presentation of a content based on the context information, in which the context information includes information on easiness of recognition of a feature at the position, the feature being in relation to the content, and the content presentation control unit controls the presentation of the content based on the easiness of recognition of the feature at the position.

According to the configuration 1, the decrease in user acceptability can be suppressed.

(Configuration 2)

The information processing system according to the configuration 1, in which the content presentation control unit presents the content relating to the feature, when the easiness of recognition of the feature at the position is equal to or more than a prescribed value.

According to the configuration 2, it is possible to prevent the situation where the user is unable to understand the relation between the presented content and the feature.

(Configuration 3)

The information processing system according to the configuration 2, including a recognition level estimation unit configured to estimate a recognition level of the user with respect to the content, in which when the easiness of recognition of the feature at the position is equal to or more than the prescribed value, and the recognition level of the user with respect to the content relating to the feature is equal to or more than a prescribed value, the content presentation control unit presents the content relating to the feature.

According to the configuration 3, it is possible to prevent the situation where the user is unable to understand the relation between the presented content and the feature.

(Configuration 4)

The information processing system according to the configuration 3, including a workload estimation unit configured to estimate a status of load of a work performed by the user, in which when the easiness of recognition of the feature at the position is less than the prescribed value, the recognition level of the user with respect to the content relating to the feature is equal to or more than the prescribed value, and a magnitude of the load of the work is less than a prescribed value, the content presentation control unit presents the content relating to the feature.

According to the configuration 4, even in the situation where the user has difficulty in recognizing the feature, the presentation of the content functions as a trigger to cause the user to notice the surrounding feature.

(Configuration 5)

The information processing system according to any one of the configurations 1 to 4, in which the information on the easiness of recognition includes information on visibility of the feature at the position.

According to the configuration 5, it is possible to control presentation of the content based on recognition difficulty attributed to the visibility.

(Configuration 6)

The information processing system according to the configuration 5, in which the context information is set for the feature with the visibility being equal to or more than a prescribed value.

According to the configuration 6, the feature that is hardly recognized can be excluded in advance.

(Configuration 7)

The information processing system according to any one of the configurations 1 to 6, in which the information on the easiness of recognition includes information on easiness of identification of the feature at the position.

According to the configuration 7, it is possible to control the presentation of the content based on recognition difficulty attributed to the easiness of identification.

(Configuration 8)

The information processing system according to the configuration 7, in which the easiness of identification is set based on the number of features of an identical kind that are present within a fixed range from the position.

According to the configuration 8, it is possible to control distribution of the content in accordance with the situation where a specific feature is hardly recognized due to a large number of the features of the identical kind.

(Configuration 9)

A method of information processing, including: a first step of a computer acquiring a position of a user; a second step of the computer acquiring context information corresponding to the position; and a third step of the computer controlling presentation of a content based on the context information, in which the context information includes information on easiness of recognition of a feature at the position, the feature being in relation to the content, and in the third step, the presentation of the content is controlled based on the easiness of recognition of the feature at the position.

According to the configuration 9, the decrease in user acceptability can be suppressed.

Reference Signs List

1 An information processing system

10 Information processing server

12 Database server

14 Content distribution server

44 Position acquisition unit

45 Driving status acquisition unit

51 Preference Information acquisition unit

52 Context information acquisition unit

53 Feature-related content specification unit

54 Preferred content specification unit

55 Recognition level estimation unit

56 Driving load estimation unit

57 Content distribution control unit (content presentation control unit)

C Client equipment

Da Content

Da1 Target feature-related content

Db Current position

Dc Visible feature (feature)

Dct Target feature

Dd Preference information

De Context information

De1 Visible feature information

De2 Recognition easiness information

Df Content information

Dk Driving status information

What is claimed is:

1. An information processing system, comprising:
a position acquisition unit configured to acquire a position of a user;
a context information acquisition unit configured to acquire context information corresponding to the position; and
a content presentation control unit configured to control presentation of a content based on the context information, wherein
the context information includes information on easiness of recognition of a feature at the position, the feature being in relation to the content, and
the content presentation control unit controls the presentation of the content based on the easiness of recognition of the feature at the position.

2. The information processing system according to claim 1, wherein the content presentation control unit presents the content relating to the feature, when the easiness of recognition of the feature at the position is equal to or more than a prescribed value.

3. The information processing system according to claim 2, comprising a recognition level estimation unit configured to estimate a recognition level of the user with respect to the content, wherein
when the easiness of recognition of the feature at the position is equal to or more than the prescribed value, and the recognition level of the user with respect to the content relating to the feature is equal to or more than a prescribed value, the content presentation control unit presents the content relating to the feature.

4. The information processing system according to claim 3, comprising a workload estimation unit configured to estimate a status of load of a work performed by the user, wherein
when the easiness of recognition of the feature at the position is less than the prescribed value, the recognition level of the user with respect to the content relating to the feature is equal to or more than the prescribed value, and a magnitude of the load of the work is less than a prescribed value, the content presentation control unit presents the content relating to the feature.

5. The information processing system according to claim 1, wherein the information on the easiness of recognition includes information on visibility of the feature at the position.

6. The information processing system according to claim 5, wherein the context information is set for the feature with the visibility being equal to or more than a prescribed value.

7. The information processing system according to claim 1, wherein the information on the easiness of recognition includes information on easiness of identification of the feature at the position.

8. The information processing system according to claim 7, wherein the easiness of identification is set based on the number of features of an identical kind that are present within a fixed range from the position.

9. A method of information processing, comprising:
a first step of a computer acquiring a position of a user;
a second step of the computer acquiring context information corresponding to the position; and
a third step of the computer controlling presentation of a content based on the context information, wherein
the context information includes information on easiness of recognition of a feature at the position, the feature being in relation to the content, and
in the third step, the presentation of the content is controlled based on the easiness of recognition of the feature at the position.
